(19) United States
(12) Patent Application Publication
(10) Pub. No.: US 2023/0040168 A1
(43) Pub. Date: Feb. 9, 2023

(54) COUPON, CONTEST, AND ADVERTISING BUSINESS METHODS

(71) Applicant: John Roark Butler, Simi Valley, CA (US)

(72) Inventor: John Roark Butler, Simi Valley, CA (US)

(21) Appl. No.: 17/970,235

(22) Filed: Oct. 20, 2022

Related U.S. Application Data
(63) Continuation-in-part of application No. 17/370,516, filed on Jul. 8, 2021.
Application No. 17/370,516 is a continuation-in-part of application No. 16/777,664, filed on Jan. 30, 2020, now abandoned.
(60) Provisional application No. 63/155,948, filed on Mar. 3, 2021.
(60) Provisional application No. 63/049,413, filed on Jul. 8, 2020.
(60) Provisional application No. 62/799,418, filed on Jan. 31, 2019.

(51) Int. Cl. G06Q 30/02

(52) U.S. Cl. CPC G06Q 30/0217; G06Q 30/0239

(57) ABSTRACT

Business methods related to contests, coupons, and advertising are described. Methods according to the disclosure can include methods related to movies and/or films, and can include company and/or product placement within the movies/films. The movies/films can be released in segments to users, and can be made using user input.

### RELATED APPLICATIONS

This application is a continuation-in-part of U.S. patent application Ser. No. 17/370,516 to Butler, filed on Jul. 8, 2021 and entitled “Coupon, Contest, and Advertising Business Methods” (published as U.S. Pub. No. 2021/0334842), which claims the priority benefit of U.S. Provisional Patent Application No. 63/155,948 to Butler, filed on Mar. 3, 2021 and entitled “Coupon, Contest, and Advertising Business Methods,” and U.S. Provisional Patent Application No. 63/049,413 to Butler, filed on Jul. 8, 2020 and entitled “Coupon, Contest, and Advertising Business Methods,” and which is a continuation-in-part of U.S. patent application Ser. No. 16/777,664 to Butler, filed on Jan. 30, 2020 and entitled “Coupon and Contest Business Methods” (published as U.S. Pub. No. 2020/0250695), which claims the priority benefit of U.S. Provisional Patent Application No. 62/799,418 to Butler, filed on Jan. 31, 2019 and entitled “Coupon and Contest Business Methods.” The entire contents of each of these five priority applications are fully incorporated by reference herein.

### BACKGROUND OF THE DISCLOSURE

### Related Art

Consumers have used paper coupons at stores for decades, if not centuries. With the advent of the smartphone, consumers now often use digital coupons, gift cards, and the like at, for example, retail stores. These digital coupons can include a bar code and be scanned on site, resulting in, for example, a discount on the product the consumer wishes to buy, or a discount on purchases from a particular company. Hundreds of millions of Americans and billions of people worldwide use coupons or similar discount method of some sort every year. Some studies have shown that when users are provided with discounts, they actually end up spending more than they would have spent without the discounts, due to buying more goods. For instance, one study has shown that 83% of the time, people who save money on a buy actually use the money saved for another buy.

Some single companies have begun to offer universal type discounts. For instance, recently the grocery store Whole Foods began offering a set percentage discount to Amazon Prime users. However, such a discount is only usable at Whole Foods and not, for instance, at other grocers or retailers. Still, this discount program has led to an overall increase in sales.

### Field of the Disclosure

The present disclosure is directed to coupon, contest, and product/company placement applications in the modern age.

### SUMMARY OF THE DISCLOSURE

With over 300 million Americans and over 5 billion worldwide consumers above the poverty line, opportunity exists for a universal coupon that provides discounts at a high volume of stores (online and/or brick-and-mortar), and/or other perks (such as free shipping), that is easily usable in the digital age.

The present disclosure provides novel and unique business methods not found in the prior art. This summary discusses two specific embodiments, but as will be made clear hereafter and as would be clear to one of ordinary skill in the art, many different variations are possible.

In the specific embodiment discussed in this summary, consumers are texted or emailed a downloadable app (or otherwise download an app) on their device, such as their cell phone, that enters them into a contest with a monetary prize. They can also use the app as a universal coupon, where they receive a certain percentage off (e.g. 10%) at brick and mortar stores and another percentage off (e.g. 25%) online, with fee or reduced shipping. Based on the current number of consumers worldwide, this app could reach over 100 million American consumers and over a billion consumers worldwide.

In addition, the business method has numerous additional components and advantages. The app can be aligned with a film, TV show, or other production, and the businesses seen in the film/show can be linked to the app such that consumers can reach those businesses through the shot, through texts, and/or through emails. Additionally, consumers can enter contests which can be entered by, for example, answering a trivia question or survey question, which can have a monetary prize. Additionally, fans can be entered into a contest where a digitized version of the winner is added to a version of the film or show as the film or show's star.

Another aspect of the business method includes the offering of free video games to all those who utilize the app, which would save consumers money they would otherwise spend. Customized add-ons for the video games can be made available for the consumers who continue to shop with the app. This is made possible by being able to buy or license the video games at a relatively low wholesale price.

Yet another aspect of the business method includes a virtual reality online video game. Consumers and gamers who use the app to save money can also be made the star of their own online virtual reality video game, using the user's digitized image. As with other video games, regular (e.g. annual) updates can also be sent out. Businesses can also be linked within the game each year with the product placements and/or company placement taking place in gameplay, which can provide those businesses with additional exposure and advertising.

Additionally, the business method can include a yearly grand prize, such as a monetary prize, for all consumers who have used the app over the year. In one embodiment, each use of the app gives the user one entry. Runner up prizes, such as additional discounts, are also possible.

One embodiment of the present business method is an app including one, two or more, or all of the following elements:
Standard brick-and-mortar and online discounts and perks for app users;
Alignment with a feature film and/or TV show where companies are placed within the film/show with links which users can use to purchase the company's products;
The opportunity to be the CG star of the movie, in one embodiment using a digitized version of the person (e.g., from photograph(s)), where the user can become the main star of the film/show;
Contests through which users can obtain monetary prizes through answering questions, such as trivia or survey questions;
Runner-up prizes such as additional discounts;
Free video games;
The ability to be the star of a user-specific virtual reality video game, with the user's likeness being used as the main game character.

Another embodiment of the present disclosure involves a contest that users may enter. This contest may be used in conjunction with coupon methods such as the coupon methods discussed above. The user can be sent information regarding the coupon and/or contest such as via email, text, call, voicemail (such as ringless voicemail), etc. This information can include, for example, a website where the user can become a coupon user and/or enter the contest. In one embodiment of the contest, a user of a coupon is automatically entered into a free contest that can include a period (e.g. monthly) prize such as, for example, a dream home up to $2 M in value, one or more cars, and/or an all-expenses-paid vacation. The user can also be offered entry into a contest for a relatively small monetary amount, such as $0.25/month, with additional prizes, such as a $5 M home given away each month. The user can be asked one or more questions upon contest entry, which can probe user demographics and/or can provide a benefit to the user if they answer (or if they answer correctly). The contest operator can receive 1) a percentage from stores where the coupon is used, such as a percentage of increase in revenue, and/or 2) the user contest entry fees. These receipts can fund the prizes.

The above has summarized some embodiments, though many different embodiments are possible.

### DETAILED DESCRIPTION OF THE DISCLOSURE

### Universal Coupon

Embodiments of the present disclosure include the distribution of universal coupons which can be used at a variety of different stores and/or online.

The universal coupon incorporated into the methods described herein can provide a number of benefits to the user. For instance, the universal coupon can result in 1) one type of discount at brick-and-mortar stores, 2) another type of discount for online purchases, and/or 3) other perks such as free shipping. For example, one specific universal coupon according to the present disclosure grants a user 10% off at all brick-and-mortar stores, 25% off at all online stores, and free shipping. Other embodiments are possible. In some embodiments, the discount is the same at both brick-and-mortar stores and online.

In some embodiments, the user is texted or emailed the universal coupon. In another embodiment, the user can download an application (e.g., a mobile application), and access the universal coupon through that mobile application.

Ancillary benefits can also be associated with the universal coupon. For instance, in some embodiments a user is entered into a contest (such as a contest with a monetary prize) whenever they download or otherwise obtain the universal coupon. In another embodiment, a user is entered into the contest when they use the universal coupon. A user could be entered into such a contest only upon the first use, upon every use, or in other manners. For instance in some embodiments, a contest is run daily for all users who have used the universal coupon on that day, or for all users who have the universal coupon downloaded (e.g., on their smart phones) on that day. Consumers may have to complete a task to be entered into a contest, such as answer a trivia question or a survey question. Additionally, simply taking part in the trivia or survey can result in a runner-up prize, such as 25% off at one or more brick-and-mortar stores associated with the universal coupon. Many different embodiments are possible.

In some instances, a user (with their consent) can be charged a relatively small amount for entry into the contests, such as $0.025 or $0.05 per entry, or $1-2/day to be permitted to enter into the contests. In some instances, users can be permitted to themselves determine how much to pay on a given day, to be entered into contests with larger potential prizes. Given the large number of anticipated users, this could fund the universal coupon. These potential charges are purely exemplary in nature.

The universal coupon will also benefit those entities which sign up to provide the discounts (e.g., a brick-and-mortar retail store that agrees to provide the 10% discount and be associated with the universal coupon, or an online retailer that agrees to provide the 25% discount and be associated with the universal coupon). These entities will receive much higher consumer traffic because of the offered discounts.

The universal coupon can include other benefits:

Product Placement: The universal coupon can be associated with films and/or television shows that feature products from companies (e.g. retailers, service providers, grocers, individuals acting in these capacities, other types of companies, etc., as should be understood throughout this disclosure) associated with the universal coupon, or feature those companies themselves (e.g., featuring that company's store or that company's storyline). The app associated with the universal coupon can link consumers to the products and/or companies that they see in films or shows, thus making purchase of those products more convenient to the user. The app can contact the user via, for example, email, or notification from the app itself. By way of example, if a user watches a movie in which the star is driving a Honda Accord, the universal coupon app may provide the user with a link to a website providing information on the Honda Accord, or through which a user can purchase a Honda Accord or find out where to purchase a Honda Accord. The owner of the featured products, or the featured companies themselves, can provide the universal coupon provider with a monetary amount in exchange for the featuring of the product, or can provide a percentage of any increase in sales. Many different embodiments are possible. Additionally, it is understood that “product placement” as described throughout this disclosure may include featuring a company as a whole and/or the company's products as a whole, without featuring a specific product (e.g., the company's retail store can be shown, or the company can be included in the storyline).

Movie/Film Contests: In some embodiments, users can also be sent a link to a movie or film that could be available in theaters and/or via online release (to which the link would send the user). Delivery of the movie/film via other methods is also possible. Users can then also be entered into contests wherein the users answer questions about the film, which they typically would not know the answer to unless they had viewed the film. These contests can have various prizes associated therewith, such as weekly contests for a monetary amount. Runner-up or secondary prizes can also be available, such as discounts from companies, such as companies who are product/company placement sponsors of the film. Questions about the film can be provided at various times, such as during viewing or after viewing. In some embodiments, the questions can be sent to users at regular intervals which can be associated with a contest, such as weekly questions associated with weekly contests. This may also encourage consumers to watch the film multiple times, due to the ongoing contests. A fee can be charged for watching the film, which can be, for example, a flat fee for unlimited watches; a first fee for a first watch and a second, lower fee for subsequent watches; or a set fee for each watch. Many different embodiments are possible. Additionally, prizes can be awarded in any number of ways. For instance, in one embodiment each user who answers a question correctly is entered with an equal chance in winning. In another embodiment, a user gets an entry for each question that is answered correctly, and as such, users with more correct answers will have a higher chance of winning. Many different embodiments are possible, and the above is only exemplary in nature.

In some embodiments, the film may be released as part of the contest prior to a full public (e.g., box office) release. It can be released all at once, or in some embodiments can be released in segments, such as a segment per week. Each segment can be associated with one or more contests.

Text Contests: In some methods according to the present disclosure, users can be charged a small amount (e.g., between $0.01 and $1.00 a day, though other amounts are possible) to enter into a contest with prizes such as, for example, a house, job, or monetary prize (e.g., a percentage of all entry fees for that contest). Secondary or runner-up prizes may also be available, and can be texted to users. Advertising can also be texted to users who have entered and consented, which can be another source of income for the contest operator. The entry fee can be automatically debited from entered users until they cancel, as in a subscription service. Additionally, a user may prepay, such as paying $1.00 for 100 contests at $0.01 each. In one embodiment, the user is not charged until they respond with an answer.

A mass text can be sent to all entered users including a question such as a trivia question, and the user that responds the fastest can be that contest's winner. The text can be sent, for example, daily, weekly, monthly, etc. Additionally, the text could be sent at the same time within the contest period every time (e.g., always at 2 PM Eastern for a daily contest; or always Tuesday at 4 PM Eastern for a weekly contest; or always on the 15^{th} of the month at 11 AM Eastern for a monthly contest). In other embodiments, the text could be sent at a randomly chosen time within the contest period. Different embodiments and combinations of these embodiments are possible. Additionally, multiple contests can be held in a single time period; for instance, three questions could be sent at various times in a single day.

Video Game Perks: The universal coupon can provide video games either free or at low cost to its users, through purchasing of licenses at wholesale. This would attract more users who would use the universal coupon because of the provided games. Additionally, product/company placement links such as those provided above can also be provided for products/companies within the video games.

As another video game perk, the universal coupon app and/or video game can form a character based on the user, such as by using facial recognition technology and adding the user's face to a character within the game. Upgrades to the game can be provided (such as via email, or through the app) on a regular basis. This video game perk can be provided as a stand-alone program specifically targeting and being provided to video game users, in some embodiments.

Other Potential Perks: Other potential user and/or business perks are possible, such as:

Users being linked, through the universal coupon, to places to buy products available from product/company placement sponsors in films or TV shows;

Fans becoming the CG star of a movie, by using facial recognition technology and substituting the user's face for that of the previous star;

Daily, weekly, monthly, and/or yearly contests for prizes such as monetary prizes, with users to answer questions in order to be entered, and/or with prizes to go to the fastest correct answerers;

The availability of prizes to all users even if they do not win, such as 25% discounts at stores associated with the universal coupon;

Free video game usage for universal coupon users, with upgrades provided periodically;

The ability for a user to become the star of their own virtual reality video game using their digitized likeness. The likeness of a user can become the main character or star of a video game, such as a virtual reality game. For example, a user can upload a picture through an app, and that picture can be used to form the main character of such a game. Additionally, within this game, product and/or company placement can occur. For example, within the game companies can place virtual versions of their product, or a brick-and-mortar store of a company can be shown/featured in the game, and a user may be able to buy that product or that company's products or services through the app and/or through the video game,; and

A “holiday in your name” contest, wherein all users or certain users (e.g., those who reach a certain spending threshold in a certain time period, such as $25/week) are eligible for a contest. The winner of the contest will have a day of the year in the user's name, e.g. “Joe's day,” on which special features may be available.

These perks are merely exemplary in nature, and it is understood that other similar perks (such as those described previously herein and similar) are also possible.

### Contest Business Method

The coupon business method above can be combined with other business methods. For instance, a user can be sent a text, call, or voicemail (e.g., a ringless voicemail) informing them of the coupon offer and how to sign up, such as by visiting a website provided in the communication. The coupon can provide, for example, 50% off on the user's shopping needs, which is enough in some instances to save money to, for example, buy a house or pay a mortgage. The 50% can be based on full retail price, as opposed to an already-discounted price. Additionally, the coupon offer can be made in conjunction with a coupon application such as the Honey app available from Honey Science LLC, which can lead to an increase in use of the discount (and thus increased revenues for stores and/or the contest operator).

The users of the coupon can be automatically entered into one or more contests provided for free based on their use of the coupon. For instance, in one embodiment, each month (or twice a month or more, or every 2 months or more) a winner can be selected to receive a dream property (e.g., a property up to $2,000,000), one or more vehicles (e.g. two vehicles up to $50,000 each), and/or a vacation including family and friends with all expenses paid. These prizes can be paid for by the stores providing the discounts, such as using the additional revenue they obtain from additional customers and purchases, and/or can be funded by the contest operator using a percentage of the revenue received from the store(s).

The contest operator can be compensated in many different ways. For instance, in one embodiment, the contest operator can receive a percentage of revenues from stores, or a percentage of revenue increase of stores that take part in the coupon. For instance, if a store goes from $10,000,000 monthly sales to $15,000,000 monthly sales, the contest operator could be entitled to a percentage of the $5,000,000 revenue increase; for instance, 1%, 2.5%, 5%, 10%, 15%, 25%, ranges within those percentages, or other percentages. In some embodiments, this could be applied to profit and/or profit increase instead of to revenue increase. Store(s) as used herein is used in a very general sense, and can include companies from fields such as but not limited to groceries, automotive, home improvement, insurance, lodging, travel, restaurants, nightlife, healthcare, fitness, internet, communications, sporting, entertainment, etc.

In place of or in addition to the above contest, the user can also be offered the opportunity to enter a contest at a low per-month cost, such as $0.25/month (less than a penny a day) or $0.02/day, though it is understood that other monetary amounts are possible (e.g. $0.10/month or less, $0.15/month or less, $20/month or less, $1/month or less, $5/month or less, $10/month or less, etc., though other smaller and larger amounts are possible). At high quantities, such a low-priced contest can result in a high return. For instance, the estimated 2019 population of the United States was approximately 325,000,000 people, with an adult (18 and over) population of over 250,000,000. Assuming approximately a 50% participation rate (given that the HGTV Dream Home Giveaway, a once-a-year contest, received approximately 127,000,000 entries in 2016 for a house worth under $2,000,000) at $0.25/month, this would result in a pool of approximately $360,000,000. Discounts on the monthly entry fee could be provided in exchange for the user paying a lump sum for the year; for instance, in one embodiment the user could pay $2.50 for entry in all 12 months, whereas paying monthly would cost $3.00.

In some embodiments, users may be allowed multiple entries. In some embodiments, the price may be significantly higher, such as $1/month or $0.10/day. Many different embodiments are possible.

Amounts can be taken from the pool to fund contest prizes. For instance, in one embodiment a dream home can be given away on a monthly (or other periodic) basis. For instance, a home worth approximately $5,000,000 can be given away to a contest winner on a monthly basis. This would result in a net profit, in the above scenario, of approximately $300,000,000. Additionally, users who entered the contest but did not win the monthly giveaway would not go empty-handed if the contest were combined with the business coupon method, in that such users could save approximately 50% on their shopping bills. It is understood that these numbers are exemplary, and that while this example is based on participation only in/from the U.S., the same concepts could be applied in place of and/or in addition to the U.S., and worldwide embodiments are possible. One or more “runner-up” or secondary prizes can also be offered, such as new vehicles.

In some embodiments the total prize(s) can be pre-determined. In other embodiments the total prize(s) can be calculated based on subscribership. For instance, in the above example, the total prize was approximately ⅙ of revenue ($60,000,000 or $360,000,000). In some embodiments, the total prize can be approximately 5% of revenue or more, approximately 10% of revenue or more, approximately 15% of revenue or more, approximately 20% of revenue or more, approximately 25% of revenue or more, approximately 40% of revenue or more, approximately 50% or revenue or more, or more than 50% of revenue; and/or can be approximately 5% of revenue or less, approximately 10% of revenue or less, approximately 15% of revenue or less, approximately 20% of revenue or less, approximately 25% of revenue or less, approximately 40% of revenue or less, approximately 50% or revenue or less, or less than 50% of revenue. Embodiments outside these ranges are possible.

In some embodiments, the prize(s) can be located in the geographic area of the prize winner; in some other embodiments, the geographic location of the prize(s) is/are predetermined. In embodiments where the prize is a property, the winner may be able to select an available property up to a certain maximum value. In some embodiments the user may be able to elect a cash option instead of another prize (e.g., a home). The cash option may be less than the total value of the other prize.

As part of the contest, one or more questions may be asked of the participants. In some embodiments, these are survey questions that can be used to, for example, refine the contest and/or website to better suit the user, such as by adding or removing certain stores. In some embodiments the questions are used to collect data, such as demographic data, on users. In some embodiments, the questions may be trivia based and/or provide a benefit to a user if they get the answer right, such as by reducing their monthly charge and/or providing extra retailer discounts. Many different embodiments are possible.

### Sneak Preview Business Method

Other embodiments of the present disclosure involve offering to potential viewers/consumers the opportunity to watch previews, segments, and/or episodes of a film or show (referred to hereinafter as “film” for simplicity purposes) prior to public release. The potential viewer/customer can be sent an email or other message type which can itself include, or can link them to a website or other medium that includes, information about an upcoming film or show. The website or other medium (referred to hereinafter as “website” for simplicity purposes) can be updated on a period (e.g., weekly) basis with a new portion of the film, so that every time the website is updated, it includes a film portion that the user has not seen before. An email or other message can be sent to the potential viewer every time the website is updated. The segments can be of any length, such as, for example, 1-30 minutes in length, 1-15 minutes in length, 1-10 minutes in length, or various other lengths within or outside of these ranges; and/or can include, the in the case of shows, an entire “episode” of the show; numerous different embodiments are possible.

In another embodiment, the segments are not from the finalized film, instead could include segments of a script (e.g., the original script or a draft script), storyboards, or a CG non-final version of the film; with a final film (e.g. a live action film) to be released at a later date.

In some embodiments, the updates are cumulative, so that the viewer will be able to see both past portions and the most recent portion. In other embodiments, each new portion replaces the previous portion, so that only the most recent portion is available.

Contests and prizes can be coordinated with these releases. For instance, in some embodiments, contests can be provided per segment based on which viewer knows the most about the most recent segment. A quiz/test can be used to determine this. The winning viewer can be given a prize, such as a cash prize, a vehicle, or a vacation, though many different types of prizes are possible.

At a certain point, the viewers may be informed that they can watch the entirety of the film spliced together, instead of in segments. The viewers may be informed of this when the final segment is released, before the final segment is released, or after the final segment is released. The viewer may be charged a fee for watching the completed film. Moreover, if the segments were of a script or a non-final (e.g., CG) version, the viewer could be offered the opportunity to watch the completed final version (e.g., live action) version, such as for a fee. Alternatively, in one embodiment, these two concepts are combined: the viewer can watch the completed non-final version (and may or may not be charged a fee), and also offered the opportunity to watch the completed final version for a fee. The completed release could be done in a traditional manner, such as via streaming, television, movie theaters, etc. In one embodiment, viewers who watch the non-final version are offered a discount on the fee to watch the finalized version. Viewers may be told beforehand (e.g., when they start watching segments) that they are watching a non-final version, or may be told when they watch the spliced-together version that there is a completed and improved (e.g., live action) version that will become available.

Additionally, a contest may be held after viewers have viewed the spliced-together, non-final version of the film, with the viewer(s) knowing the most about the film being rewarded with prize or prizes such as those previously described. The contests described herein (including both the segment contests and the spliced-together contest) may include trivia questions referencing companies and/or products that have been placed throughout the film (e.g., “Name the store that is shown behind the main character when the main character learns that her father is still alive,” or similar questions). Revenue can be earned by charging for this company/product placement in the film and/or the contests.

The website or other medium through which viewers watch segments can include advertising and product/company placement as previously described. Additionally, the website or other medium may include ordering capabilities, such that the user may purchase products or services of companies on the website.

### Choose the Star Business Method

Other embodiments of the present disclosure involve offering to potential viewers/consumers (used interchangeably hereinafter) the opportunity to affect the making of a film or show (referred to hereinafter as “film” for simplicity purposes) prior to public release. For instance, in one embodiment, the opinions of viewers/consumers are used to choose the star and/or other cast members of a film. Other embodiments are possible, such as embodiments where the opinions of viewers/consumers are used to choose the film theme, setting, outcome, and/or any number of different film attributes. Combinations of these embodiments are possible, as are other embodiments.

In one embodiment, the collection of viewers' opinions can be used as a form of publicity for the film, which has not yet been made or released. Allowing viewers to have input into the film, and the solicitation of those opinions, can serve to raise the profile and public recognition of the upcoming film, and increase overall interest.

A script and/or basic outline of the film can be developed prior to soliciting viewer input. For instance, the script can include a basic plot and/or theme, characters and/or character types, and/or a setting. Viewers' opinions can then be solicited, such as by asking them for their preferred plot outcome, preferred actor(s) for character(s), preferred setting, and so on. After giving input, a user will typically be more likely to want to see the finalized film. This could be combined with the previous methods where portions of a script (or, e.g., film, CG and/or preliminary version of film, etc.) were disclosed to viewers over time, and/or with embodiments where contests are included when portions of the script, CG film, preliminary film, etc. are released to viewers.

In some embodiments of the present disclosure, the viewer can be given options for selection (e.g., a list of five actresses to play the lead role), whereas in other embodiments the viewer response is not limited to any set options.

This opinion solicitation can be used in conjunction with product and/or company placement. For instance, product and/or company placement spots can be sold prior to or concurrently with viewer opinion solicitation. The proceeds from those sales can then be used to put into place the pieces of the finalized film, one or more of which may have been viewer-selected—e.g., to pay the salary of the viewer-selected lead actor or actress. The business method can also include promotion and/or advertising for product/company placement sponsors to viewers whose opinions are being solicited. For instance, along with voting, users can be offered various products from sponsor companies.

In one embodiment, trailers and/or some scenes of the film can already be completed, and/or can use a CG character instead of the lead actor/actress. Thus, viewers can see samples of the character within the film, which can inform the viewer's selection of a potential actor/actress to take the place of the CG character.

Potential sponsors for product and/or company placement can, in some embodiments, select the manner in which their product or company is featured. For instance, in one embodiment, a potential sponsor or sponsors can be shown a setting and/or scene, and can determine where in that setting and/or scene their product and/or company will be featured. Different locations in a setting and/or scene can be priced differently, such that the most prominent location commands a higher price than a lesser location. In an alternative embodiment, potential sponsors can instead simply pay for an undecided location for placement, and location for each sponsor can then be decided randomly and/or by the film maker. In some embodiments, lower-priced product and/or company placement spots can be sold for inclusion not in the main film, but in ancillary areas such as, for instance, an alternative ending version of the film, spin-off short films, etc.

The finalized products including user selections (e.g. viewer-selected lead actor or actress) can be distributed in any number of ways. For instance, in some embodiments, viewers who whose input was used can be given free access to the film, while other viewers are charged. In other embodiments, viewers get free access to the film if they have purchased a certain amount of products from product and/or company placement sponsors, or ordered one or more products from a certain number of product and/or company placement sponsors, etc. The film can also be available via a simple payment method (e.g., viewing the film costs $20.00, regardless of whether the viewer gave input or purchased any products).

### My Day Amenity and Business Method

In another method according to the present disclosure, a user can write a script for a perfect day of his or her life. A vote can be held to choose who had the best “My Day” script and/or CG version thereof (e.g., a CG version made based on the script), and the winner can receive their perfect day, made possible by the contest holder and/or the winner's family and friends.

### Product Placement Business Method

Another method according to the present disclosure, which can be used in conjunction with the previously described methods or other business methods as known in the art, involves product advertising for product placement companies. Specifically, this method can be used in conjunction with the previously described email methods and with other email or messaging marketing methods.

Included in an email to consumers, such as contest participants, can be links for product placement companies, such as (but not limited to) retailers and service providers. These links can be included in a prominent area of the message, such as an email or message banner and/or a top area of the message. The banner area can include, for instance, one or more companies' logos and/or slogans, and links to the company's or company's websites, where consumers can purchase products. The email can also include coupons or discounts that can be applied. The coupons/discounts can be provided independently, or can be from third party coupon providers.

The advertisements, banner, and/or prominent area can be static, or alternatively could change between companies (or products, slogans, logos, etc.), such as after a certain period of time. For instance, in one specific embodiment, two companies are featured and then switched out for two new companies after a certain period of time, such as one minute or less, or approximately 30 seconds. In an alternative embodiment, the advertisements do not change together, but instead are timed to change at different times, such as one changing every 30 seconds. The changing of companies can occur indefinitely. In order to accomplish this, a database of a large number of companies (or products, slogans, logos, etc.) can be used. For instance, in one embodiment, 1000 or more are used; in another embodiment, 2500 or more are used; in another embodiment, 5000 or more are used; in one specific embodiment, 5760 are used, corresponding to 2 companies per 30 second time slot in a 24 hour day. Many different embodiments are possible. The selection of what company or companies are shown can be random; can be random but for a limitation that a company cannot be shown twice in the same day or 24 hour period; or could be a pre-set order (e.g., alphabetical).

The above methods and concepts, including the described advertisements, banners, and/or prominent areas, as not limited to emails, but could also be included, for instance, in an app, on a website, or on a user interface.

The advertised companies can also be product placement sponsors such as those previously described. The companies featured can be the same for all recipients of the email, or can vary based on recipient. This can be done randomly, or can be based on data of the recipient using targeted advertising methods as known in the art. Also included as part of the product placement business method can be methods for users to save coupons for future use and/or a “wish list” of eventual products they wish to purchase or obtain, and/or a database of all product placement companies and the products and services they offer for browsing by users/consumers.

In another embodiment, clicking on a link in the banner can open an app on a user's phone that enables purchases.

Users of the product placement banner can also be entered in any of the above-described contests. Entry can be based on simple receipt of messages with the product placement banner, or can be limited to those users/consumers who click on a link from the product placement banner.

As another embodiment of a product placement business method, characters from a show or movie could interact with one or more retailers whose products or companies were placed in the show or movie. This interaction could occur in a separate show, in which the characters and retailer(s) are featured and discuss the retailers' products and deals. This would allow the product placement companies to showcase their bargains and promotions, and could be done as an episodic (e.g. weekly) television series.

Although the present disclosure has been described in detail with reference to certain preferred configurations thereof, other versions are possible. Embodiments of the present disclosure can comprise any combination of compatible features shown in the various figures, and these embodiments should not be limited to those expressly illustrated and discussed. Therefore, the spirit and scope of the disclosure should not be limited to the versions described above.

I claim:

1. A business method for providing discounts, comprising providing a user with a digital coupon usable at a plurality of stores to provide the user with a discount, further comprising entering the user into a contest after the user downloads or uses the digital coupon.

2. The business method of claim 1, wherein the digital coupon is provided via text message.

3. The business method of claim 1, wherein the digital coupon is provided via download of an app.

4. The business method of claim 3, wherein the app permits a user to become a character in a movie or show using facial recognition technology.

5. The business method of claim 1, further comprising asking the user one or more questions.

6. The business method of claim 5, wherein the user is provided a benefit if they answer one of said questions correctly.

7. A business method, comprising:
providing a website;
contacting at least one user to provide the address of said website;
upon said user visiting said website and entering information:
providing said user with a coupon for use at a plurality of stores; and
entering said user into a first contest with a first prize.

8. The business method of claim 7, wherein said contacting comprises contacting said user via ringless voicemail.

9. The business method of claim 8, further comprising offering said user an opportunity to enter into a second contest with a second prize for a fee.

10. The business method of claim 9, wherein at least one of said first and second prizes comprises a house.

11. The business method of claim 7, further comprising providing said user with a digital coupon usable at a plurality of stores to provide the user with a discount.

12. The business method of claim 11, further comprising charging a fee to each of said plurality of stores.

13. The business method of claim 12, wherein said fee is calculated based on a percentage of revenue increase.

14. The business method of claim 9, wherein at least one of said first and second prizes is given monthly.

15. The business method of claim 9, wherein said fee is $1/month or less.

16. The business method of claim 7, further comprising asking said user a survey or trivia question.

17. The business method of claim 7, further comprising asking said user a trivia question and providing said user with a benefit if they answer said trivia question correctly.

18. The business method of claim 7, wherein said at least one user comprises a plurality of users.

19. A business method, comprising sending a message to a plurality of users, wherein said message comprises a product placement banner in which one or more product placement companies are featured, wherein said plurality of users can activate said banner to purchase products from said one or more product placement companies.

20. The business method of claim 19, wherein said message is sent via email.
